(19) United States
(12) Patent Application Publication
(10) Pub. No.: US 2013/0246135 A1
(43) Pub. Date: Sep. 19, 2013

(54) SYSTEM, DEVICE AND METHOD OF REMOTE VEHICLE DIAGNOSTICS BASED SERVICE FOR VEHICLE OWNERS

(71) Applicant: Zhenrong Wang, Newton, MA (US)

(72) Inventor: Zhenrong Wang, Newton, MA (US)

(21) Appl. No.: 13/791,923

(22) Filed: Mar. 9, 2013

Related U.S. Application Data
(60) Provisional application No. 61/610,595, filed on Mar. 14, 2012.

(51) Int. Cl. G06F 17/00

(52) U.S. Cl. CPC G06F 17/00
USPC 705/14.4; 701/2; 701/31.4

(57) ABSTRACT

A system, device and method of remote vehicle diagnostics-based service for vehicle owners is disclosed. A vehicle diagnostics unit communicates with a vehicle's electronic control units via an OBD port. The diagnostics results are transferred to a remote server either directly or via a smart device having a wireless communication module. At the remote server, the vehicle information is processed to determine if service is necessary and if so the type of service. The vehicle information may also be shared with associated service and content providers to help in the preparation of an advisory report for the vehicle owner. The advisory report may be provided to the vehicle owner via the smart device or via an online account.

### CROSS-REFERENCES TO RELATED APPLICATIONS

This application claims the benefit of the filing date of U.S. provisional application Ser. No. 61/610,595, filed on Mar. 14, 2012.

### FIELD OF INVENTION

The present invention relates to method, system and device for providing service to vehicle owners. More specifically, the present invention is in the technical field of service to vehicle owners based on local and remote vehicle diagnosis.

### BACKGROUND OF THE INVENTION

The past four decades have witnessed an exponential increase in the number and sophistication of electronic systems in vehicles. Today, the cost of electronics in luxury vehicles can amount to more than 30 percent of the total manufacturing cost. Analysts estimate that by 2015 the number may be over 40 percent. Many of the problems that occur in automobiles today can be diagnosed with special equipment via a vehicle's on-board diagnostics port.

On-Board Diagnostics, or OBD, in an automotive context, is a generic term referring to a vehicle's self-diagnostic and reporting capability. OBD systems give the vehicle owner or a repair technician access to state of health information for various vehicle sub-systems. The amount of diagnostic information available via OBD has varied widely since the introduction in the early 1980s of on-board vehicle computers which made OBD possible. Early instances of OBD would simply illuminate a malfunction indicator light, or MIL, if a problem was detected, but would not provide any information as to the nature of the problem. By giving vehicle owners this early warning, OBD protects not only the environment but also consumers by identifying minor problems before they become major repair bills.

Modern OBD implementations use a standardized digital communications port to provide real-time data in addition to a standardized series of diagnostic trouble codes, or DTCs, which allow one to rapidly identify and remedy malfunctions within the vehicle. Various tools are available that plug in to the OBD port to access OBD functions. These range from simple generic consumer-level tools to highly sophisticated original equipment maker (OEM) dealership tools. A wide range of rugged hand-held scan tools is available, including simple trouble code readers/reset tools which are mostly aimed at consumer level. These tools may read standard trouble codes, possibly without translating the meaning, and reset those trouble codes. Professional hand held scan tools may possess more advanced functions, including but not limited to, the ability to: (a) access more advanced diagnostics information; (b) set manufacturer or vehicle specific ECU parameters; (c) access and control other control systems, such as the air bag system or anti-lock braking system (ABS); and (d) monitor and/or graph, in real-time, engine parameters to facilitate diagnosis or tuning.

The auto service industry (for services to a vehicle owner), for the purposes of this disclosure, includes but is not limited to auto service shops, roadside assistance services, auto part retail stores, auto insurance services and auto clubs. Auto service shops may provide, for example, auto repair and/or auto maintenance (e.g., oil changes). Auto repair work can be separately categorized into mechanical work and electronics work.

Current auto service consists of the interaction (and thus data flow) between the following: (a) a vehicle to be served; (b) a diagnostics device (OBD scan tools, readers, etc.); (c) a vehicle owner; (d) a vehicle owner's online account provided by third party diagnostics service company; (e) a service system of the diagnostics service company; (f) a parts retailer; and (g) an auto service company (i.e., repairing and/or maintenance). There are four conventional methods taken by a vehicle owner to get his vehicle served.

In the first method, information flows from the vehicle itself to the vehicle owner, then to the parts retailer for a do-it yourself (DIY) vehicle owner or to an auto service company for a non-DIY vehicle owner. This is the traditional approach most vehicle owners use today. In this method, a normal vehicle owner contacts an auto service company when the vehicle encounters problems or if maintenance is due. If the problems are related to an MIL light or OBD-related malfunction, very often the owner needs to drive the vehicle to the service company for diagnosis. The service technician may need to use a sophisticated diagnostics tool to diagnose the problem before provide the owner with causes, work needed, lead time and a cost estimate. This business model has several shortcomings for both the customer and auto service company. For every problem, there exists an optimized solution. The auto service company may have some experience, but it may not be enough to come up the optimized solution, or it may not want to recommend the optimized solution because of its own self-interest. The vehicle owner may not have enough knowledge or information to make correct judgments and thus usually has to follow whatever the auto service company recommends. As a result, most vehicle owners need a trusted professional source to advise them as to the causes, solutions, cost of repair, recommended service places, etc. Many minor problems can evolve to major breakdowns when not properly diagnosed and/or addressed. Early diagnosis of problems can save vehicle owners a lot of money and trouble, reduce their driving risk if the problems are safety-related, and the environment can be less polluted if the problems are emission-related. Some problems shown up as MIL signals on the dashboard, but such problems may be intermittent. It can save vehicle owners' time and money if the problems can be identified and cleared remotely.

In the second method, information flows from vehicle to the diagnostic device and then to the vehicle owner. The vehicle owner then goes to the parts retailer for a DIY vehicle owner or to an auto service company for a non-DIY vehicle owner. This is second most popular method, where a diagnostic device such as a trouble scan tool or reader is used to aid in the diagnosis. In this method, consumer level diagnostic tools (e.g., an OBD scan tool or OBD code reader) can partially solve the afore mentioned short comings. A scanner can read diagnostics trouble codes (DTC) from a vehicle's OBD port and display the corresponding description. A coder reader only reads and displays the DTC (but does not provide a corresponding description). A low-end tool costs less but can only read standard OBDII codes, making its usefulness very limited. A more advanced tool should be able to read manufacturer specific DTC, thus will be more versatile. However, there are also disadvantages associated with the consumer level diagnostics tools. A code reader only provide DTC without description, the owner has to resort to other sources to get the corresponding descriptions. Even the descriptions can be obtained, or a scan tool is used, still the owner may not understand the meaning of the descriptions, not to say the corresponding causes and solutions. The usage of scan tools is generally passive and not real time, i.e., the scanner is used when major problems have occurred.

In the third method, information flows from vehicle to vehicle owner, then between the vehicle owner and the owner's online account at the third party diagnostics service company and between the on-line account and diagnostics service company's service system, then to a parts retailer for a DIY vehicle owner, or to an auto service company for a non-DIY vehicle owner. In this method, the vehicle owner use the online service provided by a third party. Only maintenance or some mechanical issues can be handled with the help of the online service. Third party companies provide online service to help the vehicle owner to handle maintenance and simple mechanical problems. As it can be seen, all the OBD diagnostics problems are neglected, and there is no network of auto service companies and vehicle owners.

In the fourth method, information flows from the vehicle to the diagnostics device and then to the vehicle owner, then between the vehicle owner and the owner's online account at the third party diagnostics service company and between the on-line account and diagnostics service company's service system, and then to the parts retailer for a DIY vehicle owner or to an auto service company for a non-DIY vehicle owner. In this approach, the third party provides the vehicle owner with a handheld diagnostics device as well as online service to handle OBD diagnostics related problems. In this method, to address the disadvantages of consumer level scan tools, a third party company can offer a vehicle owner a handheld scan tool to diagnose a vehicle and upload scanned results to its backend server. The backend server contain database that will provide the owner a report covering description of trouble code, potential causes and fixes, and corresponding parts and labor cost. In this approach, the vehicle owner needs to manually connect the handheld scanner to the vehicle's OBD port and uploads the diagnostics data to the remote server. There are several disadvantages: first, the diagnosis is not real time; second, the diagnosis covers only standard OBD DTC; third, vehicle owners and auto service companies are not networked together.

It is an object of the present invention to provide a method, system and device which overcomes the problems discussed above.

### SUMMARY OF THE INVENTION

In an embodiment, the present invention is a device for accessing diagnostics codes from a vehicle. The device includes an OBD interface for connecting to an on-board diagnostics port in a vehicle. The device also includes a local communications interface. Finally, the device includes a controller configured to selectively communicate with a vehicle via the OBD interface to read and store diagnostic information currently available for the vehicle and to issue one or more predefined commands to the vehicle. The controller is also configured to communicate with a user via the local communications interface to provide the stored diagnostic codes and to allow the user to initiate communications with the vehicle to read the diagnostic information and/or to issue one or more of predefined commands to the vehicle. In a further embodiment, the device may also include a remote communications interface for communications with a remote server. In this further embodiment, the controller is configured to transmit the stored diagnostic information to the remote server on a predetermined basis.

In another embodiment, the present invention is a system for providing vehicle service information to a user. The system includes a vehicle diagnostics unit, a user communications device and a remote server. The vehicle diagnostics unit includes: (1) an OBD interface for connecting to an on-board diagnostics port in a vehicle; (2) a local communications interface; and (3) a controller configured to selectively communicate with a vehicle via the OBD interface to read and store diagnostic information currently available for the vehicle and to issue one or more predefined commands to the vehicle. The controller in the vehicle diagnostics unit is also configured to communicate with a user via the local communications interface to provide the stored diagnostic codes and to allow the user to initiate communications with the vehicle to read the diagnostic information and/or to issue one or more of predefined commands to the vehicle. The user communications device has a user-interface for entering commands and receiving information, a local communications interface for communicating with the vehicle diagnostics unit and a remote communications interface. The remote server has a remote communications interface for communicating with the user communications device. The controller in the vehicle diagnostics unit is configured to transmit the stored diagnostic information to the remote server via the user communications device on a predetermined basis. The remote server is configured to receive the diagnostic information and to provide initial service information based upon the received diagnostic information to the user via the user-interface in the user communications device.

In yet another embodiment, the present invention is a system for providing vehicle service information to a user. The system includes a vehicle diagnostics unit and a remote server. The vehicle diagnostics unit includes: (1) an OBD interface for connecting to an on-board diagnostics port in a vehicle; (2) a remote communications interface; and (3) a controller configured to selectively communicate with a vehicle via the OBD interface to read and store diagnostic information currently available for the vehicle and to issue one or more predefined commands to the vehicle. The remote server has a remote communications interface for communicating with the user communications device and a network interface. The remote server is configured to provide a remote user-interface via the network interface. The controller in the vehicle diagnostics unit is configured to transmit the stored diagnostic information to the remote server via the remote communications interface on a predetermined basis. The remote server is configured to receive the diagnostic information from the vehicle diagnostics unit and to provide initial service information based upon the received diagnostic information to the user via the remote user-interface.

Finally, the present invention is also directed to a method for generating and maintaining a solution knowledgebase for vehicle diagnostic data. First, diagnostics information is received from a particular one of a plurality of vehicles. Next, the received diagnostics information is compared with an information solution knowledgebase. If there is an existing solution in the information solution knowledgebase based on the received diagnostics information, an advisory report is generated for an owner of the particular vehicle. If there is no existing solution based on the received diagnostics information, a third party expert is conferred with to generate a solution based on the received diagnostics information, an advisory report is provided for the owner of the particular vehicle and the generated solution along with the associated diagnostics information is stored in the information solution knowledgebase.

### BRIEF DESCRIPTION OF THE DRAWINGS

The following detailed description, given by way of example and not intended to limit the present invention solely thereto, will best be understood in conjunction with the accompanying drawings in which:

FIG. 1 is a schematic of a vehicle owner service system according to the present invention;

FIG. 2 is a block diagram of a vehicle diagnostic unit (VDU) according to an aspect of the present invention;

FIG. 3 is a block diagram of a software application of a smart device according to an aspect of the present invention;

FIG. 4 is a flowchart of a software application of a smart device according to an aspect of the present invention;

FIG. 5 is a schematic of a remote server of a vehicle owner service system according to an aspect of the present invention;

FIG. 6 is a flowchart showing the details of customer relationship management module for the vehicle owner service system according to an aspect of the present invention;

FIG. 7 is a schematic diagram of a configuration of the vehicle owner service system according to an aspect of the present invention; and

FIG. 8 is a flowchart of a method of generating an information solution knowledgebase.

### DETAILED DESCRIPTION OF THE PREFERRED EMBODIMENT

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of the present invention. The following detailed descriptions, therefore are not to be construed in a limited sense.

The present invention relates to a remote vehicle diagnostics-based service system that consists of a vehicle diagnostics unit installed within a vehicle, a smart device with application software that connects to the vehicle diagnostics unit, and a remote backend server and associated applications for providing service and related information based on information provided from the vehicle diagnostics unit.

The system disclosed herein provides for the permanent connection of a diagnostic device to the vehicle's OBD port. The diagnostic device automatically performs a diagnosis on the vehicle every time the ignition key is turned to either the accessory (ACC) or “on” position. The diagnostic device can also run a diagnosis on demand from a smart device paired thereto (e.g., via a conventional Bluetooth® connection). In this way, the health condition for a vehicle may be checked regularly and automatically, without requiring any specific action by the vehicle owner. The diagnostics results are uploaded to a remote server for analysis via a smart device or directly via wireless communication module. In this way, the vehicle may be seamlessly connected to an auto service system which consists of the vehicle, the vehicle owner, the wireless communication module or smart device for connection to a remote network, the remote server, the vehicle owner's online account, third-party value-adding service providers, social networks, and advertisers. The vehicle owner accesses the remote server via a given online account or a software application running on the smart device. The system disclosed herein provides a normal vehicle owner (i.e., one who knows little about his or her vehicle) with a trusted professional service that advises, at appropriate times, what and how much necessary maintenance is required. In addition, the vehicle owner can also be provided with corresponding local discounts and other useful information. Further, when the vehicle has problems, even the vehicle owner has not noticed such problems, the vehicle owner has a trusted professional adviser to identify, remind and advise of the problem, the likely repair needed and cost information for the repair. This helps the vehicle owner avoid major breakdowns of the vehicle. In addition, the vehicle owner may also be provided with corresponding timely local discount and other useful information. When the vehicle owner needs roadside assistance, a one touch phone call via the present system provides for the vehicle owner service needs quickly and economically. For the other value-adding service providers within the system, such service providers have real time and accurate information allowing them to quickly help the vehicle owner—their customer.

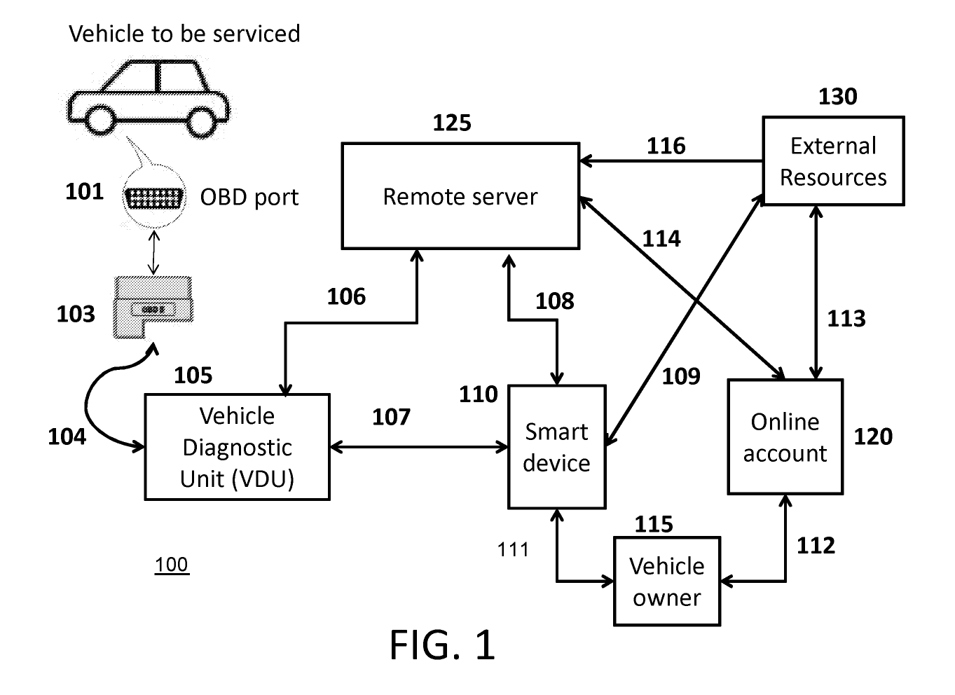

Referring now to the drawings and in particular, FIG. 1, a schematic diagram of a vehicle owner service system according to a preferred embodiment of the present invention is shown. The system is modular and scalable, which provides for several different configurations possible. The system 100 includes a vehicle including an OBD port 101, an OBD connection interface 103 (optional), a vehicle diagnostic unit (VDU) 105 which is connected to OBD port 101, either directly or via optional OBD connection interface 103. VDU 105 may be connected to a smart device 110 (e.g., a smart phone, a tablet computer, a laptop computer, etc.) via a conventional interface (e.g., Bluetooth®) and an application running on such smart device. VDU 105 may also be connected directly to a remote network 125 via a wireless communication link. The smart device 110 may also communicate directly with remote server 125, as shown in FIG. 1. Further, the vehicle owner 115 may access information about the vehicle via software application with smart device 110 or an online account 120 (e.g., access using a personal computer coupled to the Internet via a web server application running on the remote server). Finally, external resources 130, including but not limited to service providers (SP), content providers (CP), advertisers, social networks, and vehicle owner 115's peer car owners (who own vehicles of the same model and year) are coupled to remote server 125, smart device 110 and the online account 120 so that the vehicle owner can access information from such external resources 130 using either the smart device 110 and the online account 120.

In more detail, still referring to the embodiment of FIG. 1, there are several bi-directional communication interfaces shown for sending and receiving data or information. The communications include: (1) interface 104 between VDU 105 and OBD port 101 via optional OBD connecting line 103; (2) interface 106 between VDU 105 and remote server 125; (3) interface 107 between VDU 105 and smart device 110; (4) interface 108 between smart device 110 and remote server 125; (e) interface 109 between smart device 110 and service/content provider 130; (f) interface 111 between smart device 110 and vehicle owner 115; (g) interface 112 between vehicle owner 115 and vehicle owner online account 120; (h) interface 113 between vehicle owner online account 120 and service/content provider 130; (i) interface 114 between vehicle owner online account 120 and remote server 125; and (j) interface 116 between remote server 125 and service/content provider 130. Each of the above communications interfaces may be implemented via a predetermined protocol and/or structure. Furthermore, interface 116 may operate according to an application programming interface (API) that is available to third party software application development companies, so that the data collected by remote server 125 can be used for special applications such as but not limited to gaming, education, vehicle quality study, and etc.

VDU 105 reads diagnostic trouble codes (DTCs) and other data from OBD port 101. VDU 105 also can send messages (e.g., a clear trouble code command) to OBD port 101. The actions performed by VDU 105 are controlled by several input signals: (1) external signals such as the status of the vehicle's ignition key, battery voltages identifying whether the engine is turned on or off; (2) commands from remote server 125; and (3) commands from smart device 110.

As discussed above, VDU 105 may be connected to a vehicle's OBD port 101 directly or via an OBD connecting line 103. Connecting line 103 may be necessary when the space surrounding the OBD port 101 is too small to allow the VDU 105 to be connected directly. Smart device 110 may be a smart phone using operating systems such as Android, iOS, etc., a tablet computer, a laptop computer, or even a desktop computer. The connection 107 between VDU 105 and smart device 110 may be wired (e.g., via a USB interface) or wireless (e.g., using a Bluetooth® or wireless local area network according to 802.11 technology). The interface 108 between smart device 110 and remote server 125 may be via a wireless communications interface such as GPRS, GSM, and CDMA. Likewise, the interface 106 between VDU 105 and remote server 125 may be via a wireless communications interface such as GPRS, GSM, and CDMA.

As mentioned in Background of the Invention, there are many diagnostic tools on the market, including diagnostic tools designed to use proprietary communication protocols to communicate with an external device. VDU 105 is configured to communicate with smart device 110 via interface 107. An application running on smart device 110 may be designed to conform to a proprietary protocol used by a third party diagnostic tool (e.g., ELM-327). In this way, the system can be open and applicable to other diagnostic tools. On the other hand, a communication protocol of VDU 105 may be published and open to the public for third party use.

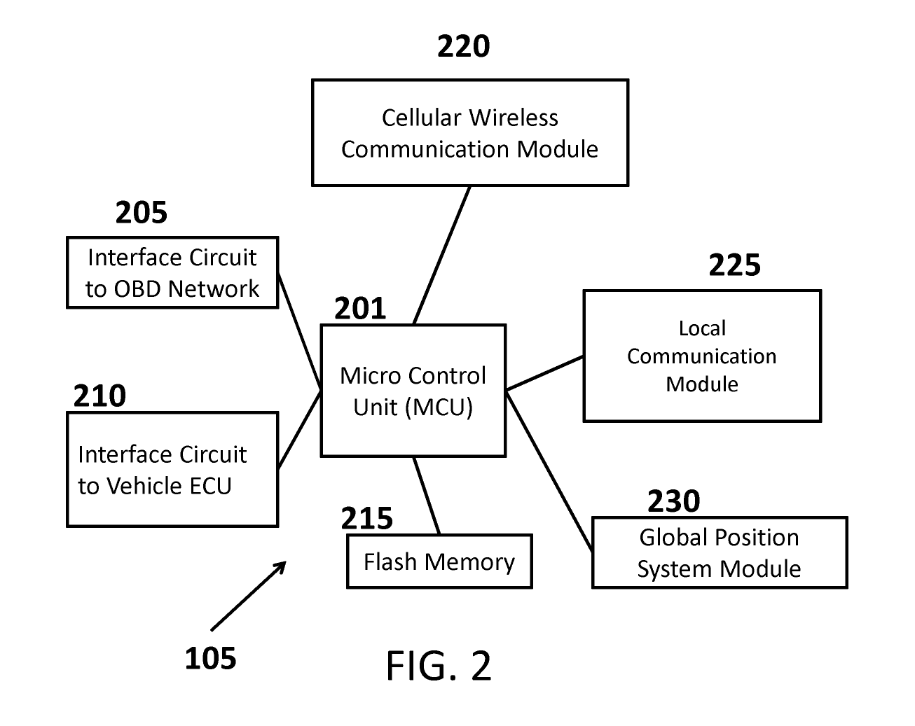

Referring now to FIG. 2, a modular block diagram of VDU 105 is shown. As shown in FIG. 2, VDU 105 may include a microcontroller unit (MCU) 201 that controls all the functions of VDU 105, an interface 205 for bidirectional communication with MCU 201 and the vehicle's network (e.g., a CAN bus or ISO K line serial interface) via OBD port 101 (with or without the OBD connecting line 103), an interface 210 for bidirectional communication between MCU 201 and individual vehicle electronics control units (ECU) or sensors. The signal can be either digital or analog. VDU 105 may also include a flash memory 215 (which may be external), a module 220 for wireless communication to remote networks (e.g., via a 3G or 4G-type network), a communication module 225 for communication with local external devices via wired (e.g., USB or RS232 interface) or wireless communication (e.g., a Bluetooth® or wireless network), a global positioning system module (GPS) 230 (either as an integral part or as a coupled external device).

MCU 201 in VDI 105 is programmed to operate as follows. First, the diagnostics program module may be compatible with both the standard OBDII protocol and vehicle manufacturers' specific protocols. Further, the diagnostics program may be configured to use a specific protocol via remote server 125 or smart device 110. This may be done by storing a specific protocol symbol in a specific memory address for the diagnostics program to read, for example, the character “T” stored in memory may indicate that a Toyota specific protocol should be used. When VDU 105 is installed permanently in a vehicle, e.g., inside a vehicle's dash panel, the diagnostics program may be configured to share the OBD communications interface with vehicle ECU to an external scanning equipment. VDU 105 may be configured to yield communications in this situation, for example when an external scanning device is connected to communicate with the ECU, a request will be sent to the ECU, and if VDU 105 was turned on to communicate with the vehicle's ECU before this, the firmware of VDU 105 will be able to “hear” the request and predesigned to yield the communication to external scanning devices. Further, MCU 201 may be configured to identify vehicle crash (collision) status based on a preset threshold of speed change with time (acceleration). The speed signals can be obtained from a vehicle's ABS system. Still further, MCU 201 may be configured to add comfort features to a vehicle's electronic circuits. For example, MCU 201 may be configured automatically roll up a vehicle's power windows when the vehicle security system is activated and/or to lock or unlock a vehicle's door remotely from the server or wirelessly via the smart device. Yet further, MCU 201 may be configured to supplement a vehicle's existing security features with a vibration sensor that senses a collision and causes a vehicle's light to flash and/or horn to sound.

Flash memory 215 may be used for several purposes, including to store diagnostic data that may be read by the software application of smart device 110, for event triggered data logging with the data used for insurance support, driving habit study, etc., and for temporary memory storage for software updates.

Wireless communication module 220 may include functionality to provide a WIFI hotspot to enable other devices in the vehicle to connect to the Internet.

The interface 104 between VDU 105 and the vehicle's OBD port 101 may be either temporary (e.g., on-demand) or permanent. For a permanent installation, if the direct plug-in of VDU 105 to OBD port 101 creates interference or cannot be done due to limited spacing for example, VDU 105 may be installed inside a vehicle's dashboard panel via an OBD connecting line 103. As discussed above, VDU 105 may be configured to yield communications with the vehicle's ECU when an external scanning device is connected. OBD connecting line 13 may include be designed in a “Y” configuration, i.e., with a male input for connection to the vehicle OBD port and two female outputs for connection to two separate scan devices, i.e., one output replaces the vehicle's original female OBD port 101 for connection to an external scan device and the other output connects to VDU 105. The permanent installation of VDU 105 using a connecting cable 103 ensures that scanning always occurs upon vehicle activation and that interior space needed for other accessories is not used (since VDU 105 can be placed on the dashboard, for example). The use of connecting cable 103 also ensures that there is no need to unplug VDU 105 when a third party needs to diagnose the vehicle via OBD port 101.

Communication module 225 may be used to connect VDU 105 with external devices such as a personal navigation device, personal digital assistant, in-vehicle audio-video-navigation device (AVN), tablet computer, smart phone, etc. Such external devices may serve as an interface between the vehicle owner 115 and VDU 105, remote server 125 and the Internet. However, in some cases the chosen local external device may contain a communications interface able to separately access remote server 125 (e.g., via a 3G or 4G network, or wireless local area network according to 802.11 technology) and for these cases wireless communication module 220 may not be necessary.

The disclosed system avoids an unnecessary draw of the vehicle's battery power by one of several alternative methods. First the system may be configured to activate based on the position of the ignition key by using the vehicle's ACC analog voltage signal (if available) provided by the female OBD port 101. Alternatively, the system may use an MCU 201 that supports external power drive from a simple peripheral power control which uses the OBD port 101's CAN H and L digital signal as input signal. In particular, the peripheral power control circuit interfaces with the on-board diagnostics port's CAN H and L signals so that the controller is powered on when the CAN H line is asserted and set to a hibernating-low-power condition when the CAN L line is asserted. In a further alternative, the system may connect to a vehicle's other onboard device's ACC signal (e.g., tap into the power line for the radio or audio-video-navigation system). Still further, the system may use an external manual on-off switch.

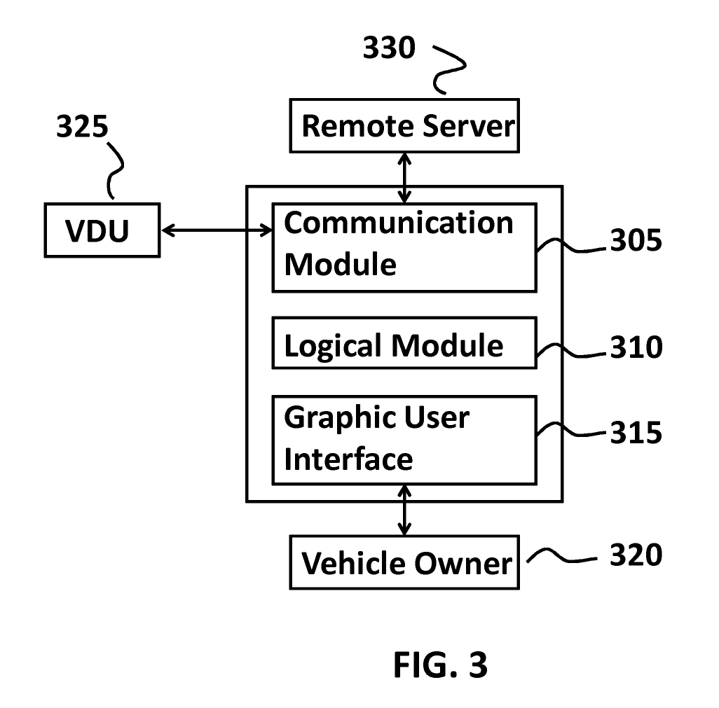

Referring now to FIG. 3, a block diagram is provided for the digital interface of smart device 110. As shown, the digital interface includes a communication module 305, a logical module 310, a graphic user interface module 315, an interface 320 with the vehicle owner 115, an interface 325 with the VDU 105 and an interface 330 with remote server 125.

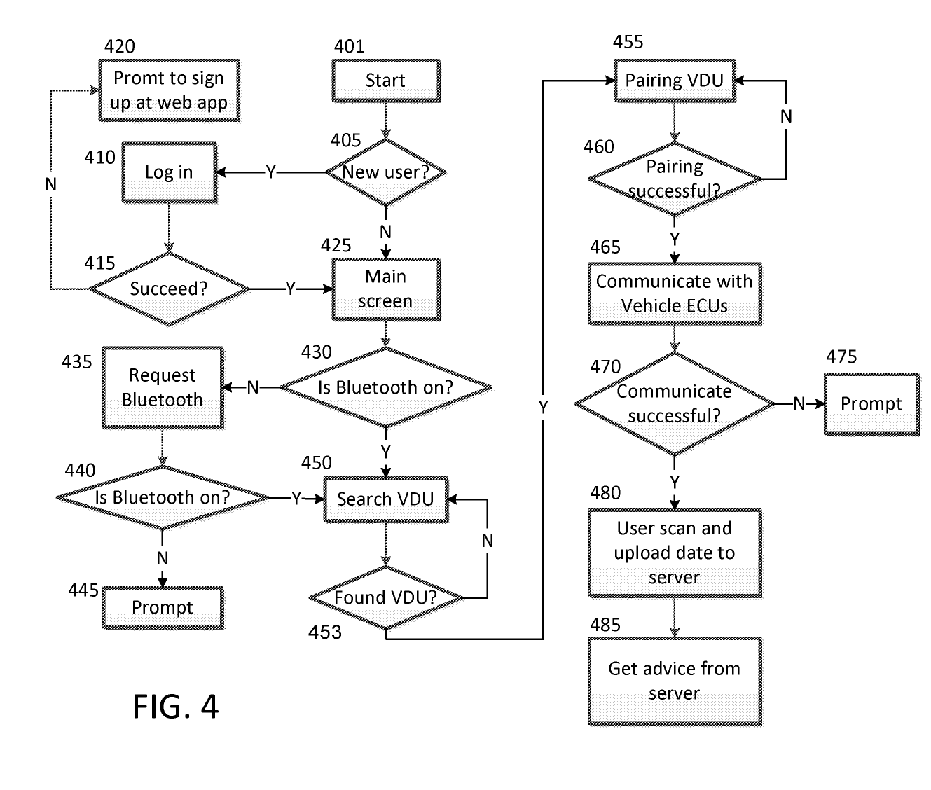

Referring now to FIG. 4, a flow chart of the operation of the software application running on smart device 110 is shown. In particular, processing starts at step 401 and then proceeds to step 405, where it is determined if the vehicle owner is a “new user.” If the vehicle owner is a new user, processing proceeds to step 410, where the vehicle owner is prompted to “login.” If the login step fails (as evaluated at step 415), the vehicle owner is prompted to use a web application to sign up for a new account at step 420. If the login step succeeds (as evaluated at step 415), processing proceeds to step 425. Processing also proceeds directly to step 425 when it is determined, at step 405, that the vehicle owner is not a new user. From step 425, processing may proceed to step 430, where it is determined if the communications interface (e.g., Bluetooth®) is enabled. If enabled, processing proceeds to step 450. If the communications interface is not enabled, processing proceeds to step 435 to request that it be enabled, and then to step 440 to verify that it is enabled. If found enabled at step 440, processing proceeds to step 450. If found not enabled at step 440, the user is prompted with a communications failure at step 445. At step 450, the unit searches for a local VDU. If a local VDU is found, as verified at step 453, processing proceeds to step 455. If no local VDU is found, processing loops back to step 450 to search for a local VDU again. At step 455, the VDU is paired with the smart device, and the pairing is verified at step 460. If pairing was successful, processing proceeds to step 465. If the pairing was not successful, processing reverts to step 455 to try the pairing again. At step 465, the VDU communicates with the vehicle ECUs to establish communication. If the communication is established successfully (as verified at step 470), processing proceeds to step 480. If the communication is not established successfully, as determined at step 470, processing proceeds to step 475 where the user is prompted with a communication failure. At step 480, the smart device reads diagnostics data from vehicle ECU via VDU, and uploads the data to the remote server. At step 485, the server provides the smart device with advice information for the vehicle owner based upon the diagnostics data uploaded.

Preferably the MAC address of the Bluetooth® chip may be used to register the VDU 105 in the remote service system via the smart device software application tool. In addition, contact name and phone number, user account number and password, zip code, distributor number and vehicle brand, model and plate number may be used for registration. The application software may communicate with VDU 105 at preset intervals to check for new diagnostics results to be sent to remote server 125. On-demand diagnostics commands may also be sent to VDU 105 to read latest diagnostics results directly. The data uploading and downloading steps 480 and 485 may be via the remote wireless network of the smart device 110. The application may read trouble codes and other data from VDU 105 and may sends commands that clear the trouble codes and other commands to VDU 105. The application may include the functions of a typical OBD scanner including, but not limited to, display freeze frame data, DTC, clear trouble code, O2 sensor monitor results, continuous and noncontiguous monitor results. It may also include a graphical gauges display for vehicle enthusiasts to measure available real time data. The application receives from remote server 125 the program update of MCU 201 to upgrade VDU 105.

The software application may connect with one or more social networks to obtain pertinent information, e.g., by posting identifying diagnostic codes and requesting service advice based thereon. Furthermore, the software application may connect with an advertiser engine to enable profit sharing for referral of business and with external service/content providers. Based on the owner uploaded information, the application may obtain information of time-sensitive, geo-dependent and event-dependent discount sales information from various sources (i.e., a local Groupon, a coupon or sales flyer from AutoZone®, etc.). The application may include vehicle maintenance scheduling functions based on monitored vehicle's brand, model, last maintenance date and actual mileage. The application may include an “SOS” button which, with one touch, uploads the diagnostics results to the server and directs the smart device to call a customer help number. The application may save and upload a vehicle driver's driving habit information for a special program in the remote server to analyze and provide advice on improving the driver's driving habit for both safety and fuel economy. The application may also be used to store vehicle parking spot information to aid the driver to find the vehicle later.

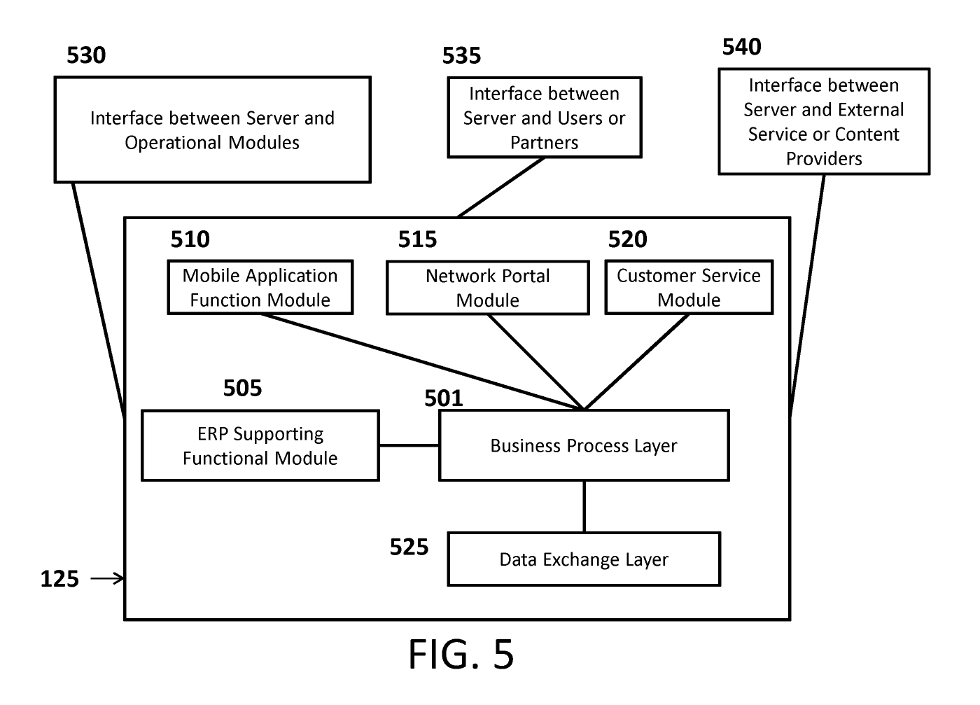

Referring now to FIG. 5, a modular and scalable configuration of remote server 125 is shown which has three layers (data exchange, business process, and business application) and the following modules: (1) business process layer 501 of the server construction; (2) supporting functional module 505 of enterprise resource planning (ERP); (3) mobile application functional module 510 as part of the business application layer of the server construction; network portal module 515 as part of the business application layer of the server construction; customer service functional module 520 as part of the business application layer of the server construction; data exchange layer 525 of the server construction; interface 530 between the server and operational modules such as purchasing, production, sales and finance; interface 535 between the server and users (e.g. vehicle owners, distributors) or partners (e.g. insurance, parts); and interface 540 between the server and external service or content providers (e.g., roadside service, insurance, etc.) or content providers (advertisements, newspapers, etc.).

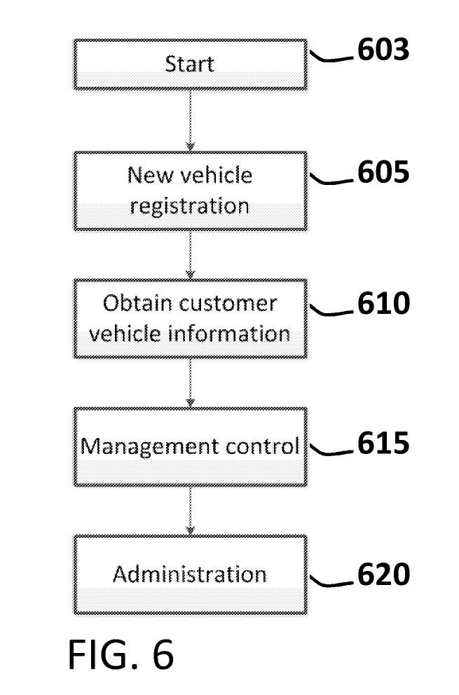

Referring now to FIG. 6, there is shown a flow chart of customer relationship management software module (CRM) of a vehicle owner service system according to the present embodiment. Step 603 shows the start of this module. Step 605 refers to new customer registration and customer information management. Step 610 refers to the obtaining a customer vehicle's information including diagnostic trouble code (DTC) data, mileage and maintenance data, and emergence help request information. Step 615 refers to a management control module used by managerial persons to monitor CRM activities. Finally, step 620 identifies an administration module that is used to set up accessibility for each CRM owner, and a related template for outgoing information provided to each CRM owner.

In particular, step 605 may request information such as contact name and phone number, user account number and password, zip code, distributor number and vehicle brand, model and plate number for registration. This information may be obtained via interaction with the application running on smart device 110, a direct telephone call with vehicle owner 115, or other similar methods. The vehicle information for step 610 may come directly from VDU 105 or via smart device 110 using, for example, a linked wireless communications network.

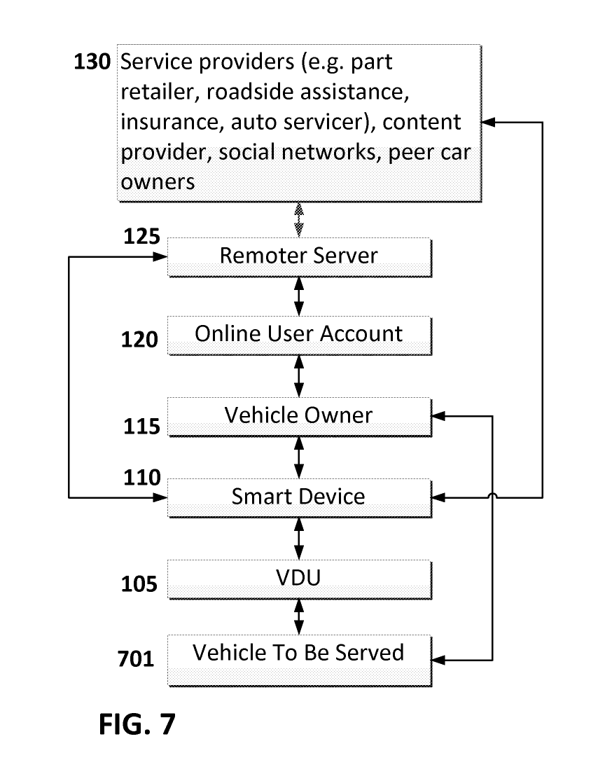

Referring now to FIG. 7, a schematic configuration of the vehicle owner service system is shown. The system includes the following blocks: (1) a vehicle to be serviced 701; (2) a vehicle diagnostics unit (VDU) 105; (3) a smart device 110 that includes an associated software application; (4) a remote server 125; (5) a vehicle owner 115; (6) a user online account 120; and (7) an interface 130 to service and content providers and social networks. The system operates as follows: every time vehicle owner 115 turns on the ignition key of vehicle 701, VDU 105 reads and stores vehicle diagnostics results. When a smart device 110 of vehicle owner 115 is within the wireless communications range of VDU 105, the application software of smart device 110 generates a time-triggered action to read the diagnostics results (e.g., diagnostic trouble codes and mileage data) from VDU 105. If new diagnostic trouble codes appear within the results, the new results are stored in smart device 110 and then uploaded to remote server 125 where the results are used to check with a DTC database system and associated expert system to identify the corresponding fault description, potential causes, likely repairs and cost thereof. The above process can also be on-demand initiated by vehicle owner 115 via smart device 110. The vehicle owner 115 activates the smart device 110 to send a command to VDU 105 to read diagnostics data (e.g., diagnostic trouble codes and mileage data) and upload the data to remote server 125 for advice on repair and/or maintenance. Mileage data and time are used as an input to maintenance scheduling algorithm of the application software of smart device 110 to determine maintenance needs of the vehicle. Both diagnostic and maintenance results are fed to corresponding service providers and content providers and social networks 130. Each of the corresponding service providers and content providers and social networks 130 provides feedback for results within the scope of services provided thereby. For example, an auto part retailer provides feedback on the related parts selection information, an auto insurance company sends a renewal reminder based on the date, an auto service company provides quotations based on the vehicle's location and needs. Based on all the acquired feedback information, remote server 125 generates a pertinent service report and sends it to the online account 120 and/or smart device 110 of vehicle owner 115.

For mechanical problems that vehicle owner 115 can physically identify, the vehicle owner uses online account 120 or smart device 110 to upload the symptoms to the remote server 125 or posts the symptoms to related social network sites 130. Remote server 125 includes an expert system that generates a solution for vehicle owner 115 based on the uploaded symptoms. The solution report will be sent to the vehicle owner 115's online account 1-20 or smart device 110.

A maintenance scheduling program is provided in both smart device 110 and online account 120 which allows the vehicle owner to record maintenance activities and upload that information to remote server 125. Based on the corresponding maintenance record, mileage and time information, remote server 125 sends maintenance advice to smart device 110 and online account 120. Service or content providers 130 may also send target advertising information to vehicle owner 115 based on such information.

In a further embodiment, information related to vehicle owner 115 and any associated service needs (e.g., based on diagnostic codes) may uploaded to remote server 125 and then made available to auto service providers to allow bidding on the work for vehicle owner 115.

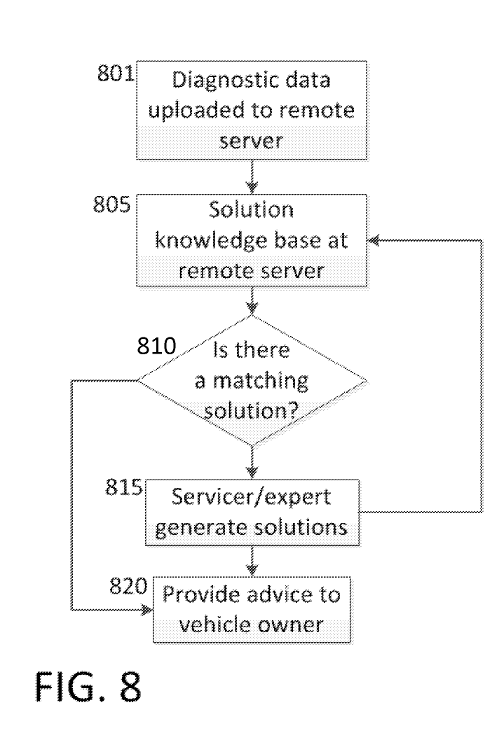

Referring now to FIG. 8, a flow chart is shown of the process to apply and maintain a solution knowledgebase for vehicle diagnostic data at remote server 125. In particular, diagnostics data 801 is uploaded to remote server 125, checked with solution knowledgebase 805. At step 810, if there is a ready solution to diagnostic data 801, remote server 125 will automatically generate an advisory report 820 for vehicle owner 115. Otherwise, diagnostics data 801 will be presented to auto servicer or expert 815 to generate a solution. The new solution, on the one hand, will be used to generate an advisory report for vehicle owner 115. On the other hand, it will be store in solution knowledgebase 805 for future use.

The advantages of the system disclosed herein include, without limitation, the application of telematics technology to improve and modernize the auto service industry by automatically linking auto service/content providers to the real time and specific needs of target vehicles. The system links the vehicle owner to a trusted and cost effective source of professional service advice for vehicle maintenance and repair. The service operates twenty-four hours a day for the duration of vehicle ownership. The present system allows auto service/content providers to timely and accurately identify the service needs of a target vehicle. Further, utilizing social network, web2.0/3.0 and data mining technology and with the wide application of this system, the service provided is efficient and thus less costly.

While the present invention has been particularly shown and described with reference to the preferred embodiments and various aspects thereof, it will be appreciated by those of ordinary skill in the art that various changes and modifications may be made without departing from the spirit and scope of the invention. It is intended that the appended claims be interpreted as including the embodiments described herein, the alternatives mentioned above, and all equivalents thereto.

What is claimed is:

1. A device for accessing diagnostics codes from a vehicle, comprising:
an OBD interface for connecting to an on-board diagnostics port in a vehicle;
a local communications interface; and
a controller configured to selectively communicate with a vehicle via the OBD interface to read and store diagnostic information currently available for the vehicle and to issue one or more predefined commands to the vehicle, the controller also configured to communicate with a user via the local communications interface to provide the diagnostic information and to allow the user to initiate communications with the vehicle to read the diagnostic information and/or to issue one or more of predefined commands to the vehicle.

2. The device of claim 1, wherein the controller is also configured to provide an identification number to the user via the local communications interface.

3. The device of claim 2, wherein the local communications interface is a wireless interface that operates according to a Bluetooth® protocol.

4. The device of claim 3, wherein the identification number is a MAC address assigned to the local communications interface.

5. The device of claim 2, wherein the local communications interface is a wireless interface that operates according to a wireless local area network protocol.

6. The device of claim 5, wherein the identification number is a MAC address assigned to the local communications interface.

7. The device of claim 1, further comprising a remote communications interface for communications with a remote server and wherein the controller is configured to transmit the stored diagnostic information to the remote server on a predetermined basis.

8. The device of claim 7, wherein the predetermined basis comprises after each communication with the vehicle.

9. The device of claim 7, wherein the controller is also configured to transmit an identification number to the remote server via the remote communications interface along with the stored diagnostic information.

10. The device of claim 9, wherein the local communications interface is a wireless interface that operates according to a Bluetooth® protocol.

11. The device of claim 10, wherein the identification number is a MAC address assigned to the local communications interface.

12. The device of claim 9, wherein the local communications interface is a wireless interface that operates according to a wireless local area network protocol.

13. The device of claim 12, wherein the identification number is a MAC address assigned to the local communications interface.

14. The device of claim 1, wherein the controller is configured to selectively communicate with one or more vehicle computer control units via the OBD interface to read diagnostic information from and/or to issue one or more predefined commands to the individual computer control unit.

15. The device of claim 14, wherein the vehicle computer control unit is one of an engine control unit, a transmission control unit, an airbag control unit or an ABS control unit.

16. The device of claim 7, further comprising a global position system module for identifying current location information and wherein the controller is configured to transmit current location information to the remote server along with the stored diagnostic information.

17. The device of claim 1, wherein the controller is configured to communicate via the OBD port in a selectable one of a plurality of predefined protocols.

18. The device of claim 17, wherein one of the predefined protocols is a standard OBD protocol and another of the predefined protocols is a vehicle manufacturer-specific protocol.

19. The device of claim 1, wherein the controller is configured to detect whether a second device is also coupled to the vehicle on-board diagnostics port and to defer any further communications via the OBD interface until the second device is no longer coupled to the vehicle on-board diagnostics port.

20. The device of claim 14, wherein the controller is configured to detect a vehicle collision based upon status information received from at least one of the one or more vehicle control units.

21. The device of claim 14, wherein the vehicle includes a security control system and wherein the controller is configured to issue commands to the security control unit to cause one or more windows in the vehicle to close upon activation of the security system.

22. The device of claim 14, wherein the vehicle includes an electrically controlled locking system for doors and wherein the controller is configured to selectively issue commands to the security control unit to cause the vehicle to lock or unlock the vehicle doors.

23. The device of claim 14, further comprising a vibration sensor for detecting a collision or intrusion and wherein the controller is configured to issue commands to the security control unit to cause lights in the vehicle to flash or a horn in the vehicle to sound upon detection of a collision or intrusion.

24. The device of claim 1, further comprising a flash memory for non-volatile storage of information.

25. The device of claim 24, wherein the information comprises diagnostic trouble codes and data.

26. The device of claim 24, wherein the information comprises event-triggered logging of data.

27. The device of claim 1, wherein the local communications interface is a wired USB interface.

28. The device of claim 1, further comprising a peripheral power control circuit having an input adapted to be coupled to CAN H and L signals for a vehicle via the OBD interface, the peripheral power control circuit also coupled to the controller, the peripheral power circuit configured to provide power to the controller when the CAN H signal is asserted and to cause the controller to enter a low power hibernation state when the CAN L signal is asserted.

29. A system for providing vehicle service information to a user, comprising:
a vehicle diagnostics unit comprising: (1) an OBD interface for connecting to an on-board diagnostics port in a vehicle; (2) a local communications interface; and (3) a controller configured to selectively communicate with a vehicle via the OBD interface to read and store diagnostic information currently available for the vehicle and to issue one or more predefined commands to the vehicle, the controller also configured to communicate with a user via the local communications interface to provide the stored diagnostic information and to allow the user to initiate communications with the vehicle to read the diagnostic information and/or to issue one or more of predefined commands to the vehicle;
a user communications device having a user-interface for entering commands and receiving information, a local communications interface for communicating with the vehicle diagnostics unit and a remote communications interface;
a remote server having a remote communications interface for communicating with the user communications device; and
wherein the controller in the vehicle diagnostics unit is configured to transmit the stored diagnostic information to the remote server via the user communications device, wherein the remote server is configured to receive the diagnostic information and to provide initial service information based upon the received diagnostic information to the user via the user-interface in the user communications device.

30. The system of claim 29, wherein the controller in the vehicle diagnostics unit includes a memory for storing firmware controlling the operation of the controller, wherein the remote server is configured to transmit firmware updates to the vehicle diagnostics unit via the user communications device.

31. The system of claim 29, wherein the remote server is coupled to social networks associated with the user and is configured to obtain additional service information based upon the diagnostic information via the social networks and to provide the additional service information to the user via the user communications device.

32. The system of claim 29, wherein the remote server is coupled to an advertisement engine and is configured to obtain additional service information based upon the diagnostic information via the advertisement engine and to provide the additional service information to the user via the user communications device.

33. The system of claim 32, wherein the additional service information includes time-sensitive, geo-dependent or event-dependent discount sales information.

34. The system of claim 29, wherein the remote server is coupled to a network of auto service providers, wherein the remote server is configured to provide the initial service information to the network of auto service providers, to receive quotation information from one or more of the auto service providers based upon the initial service information, and to provide the quotation information to the user via the user-interface in the user communications device.

35. The system of claim 34, wherein the quotation information is in the form of a bid for service to the automobile.

36. The system of claim 29, wherein the user communications device communicates with the vehicle diagnostics unit via a predetermined protocol.

37. The system of claim 36, wherein the predetermined protocol is an open standard protocol.

38. The system of claim 29, wherein the remote communications interface in the remote server operates according to a predetermined application programming interface.

39. The system of claim 29, wherein the vehicle diagnostics unit further comprises a remote communications interface and wherein the controller in the vehicle diagnostics unit is configured to transmit the stored diagnostic information to the remote server via the remote communications device.

40. The system of claim 29, wherein the user communications device is configured to allow a user to initiate communications, via the vehicle diagnostics unit, with the vehicle to read the diagnostic information and/or to issue one or more of predefined commands to the vehicle.

41. A system for providing vehicle service information to a user, comprising:
a vehicle diagnostics unit comprising: (1) an OBD interface for connecting to an on-board diagnostics port in a vehicle; (2) a remote communications interface; and (3) a controller configured to selectively communicate with a vehicle via the OBD interface to read and store diagnostic information currently available for the vehicle and to issue one or more predefined commands to the vehicle;
a remote server having a remote communications interface for communicating with the user communications device and a network interface, wherein the remote server is configured to provide a remote user-interface via the network interface; and
wherein the controller in the vehicle diagnostics unit is configured to transmit the stored diagnostic information to the remote server via the remote communications interface on a predetermined basis, wherein the remote server is configured to receive the diagnostic information from the vehicle diagnostics unit and to provide initial service information based upon the received diagnostic information to the user via the remote user-interface.

42. The system of claim 41, wherein the controller in the vehicle diagnostics unit includes a memory for storing firmware controlling the operation of the controller, wherein the remote server is configured to transmit firmware updates to the vehicle diagnostics unit via the remote communications device.

43. The system of claim 41, wherein the remote server is coupled to social networks associated with the user and is configured to obtain additional service information based upon the diagnostic information via the social networks and to provide the additional service information to the user via the remote user-interface.

44. The system of claim 41, wherein the remote server is coupled to an advertisement engine and is configured to obtain additional service information based upon the one or more diagnostic codes via the advertisement engine and to provide the additional service information to the user via the remote user-interface.

45. The system of claim 44, wherein the additional service information includes time-sensitive, geo-dependent or event-dependent discount sales information.

46. The system of claim 41, wherein the remote server is coupled to a network of auto service providers, wherein the remote server is configured to provide the initial service information to the network of auto service providers, to receive quotation information from one or more of the auto service providers based upon the initial service information, and to provide the quotation information to the user via the remote user-interface.

47. The system of claim 46, wherein the quotation information is in the form of a bid for service to the automobile.

48. The system of claim 41, wherein the remote communications interface in the remote server operates according to a predetermined application programming interface.

49. The system of claim 41, further comprising a user communications device having a local user-interface for entering commands and receiving information and a local communications interface for communicating with the vehicle diagnostics unit; and
wherein the vehicle diagnostics unit further comprises a local communications interface for communicating with the user communications device.

50. The system of claim 49, wherein the user communications device further comprises a remote communications interface for communicating with the remote server.

51. The system of claim 50, wherein the controller in the vehicle diagnostics unit is configured to transmit the stored diagnostic information to the remote server via the user communications device on a predetermined basis.

52. The system of claim 49, wherein the user communications device is configured to allow the user to initiate communications with the vehicle to read the diagnostic information and/or to issue one or more of predefined commands to the vehicle.

53. The system of claim 41, further comprising a user communications device having a local user-interface for entering commands and receiving information and a remote communications interface for communicating with the remote server; and
wherein the remote server is configured to provide service information based upon the received diagnostic information to the user via the local user-interface.

54. A method for generating and maintaining an information solution knowledgebase for vehicle diagnostic data, comprising the steps of:
receiving diagnostics information from a particular one of a plurality of vehicles;
comparing the received diagnostics information with an information solution knowledgebase;
if there is an existing solution in the information solution knowledgebase based on the received diagnostics information, generating an advisory report for an owner of the particular vehicle; and
if there is no existing solution based on the received diagnostics information, confer with a third party expert to generate a solution based on the received diagnostics information, provide an advisory report for the owner of the particular vehicle and store the generated solution along with the associated diagnostics information in the information solution knowledgebase.
